(19) United States
(12) Patent Application Publication
(10) Pub. No.: US 2003/0080645 A1
(43) Pub. Date: May 1, 2003

(54) High inductance coil and method for making

(76) Inventor: Gregory S. Graham, Ventura, CA (US)

Correspondence Address: Michael G. Petit, P.O. BOX 91929, Santa Barbara, CA, 93190-1929, US

(21) Appl. No.: 10/021,108

(22) Filed: Oct. 29, 2001

(51) Int. Cl. H02K 17/00; H02K 19/00; H02K 21/00

(52) U.S. Cl. 310/208; 310/207

(57) ABSTRACT

An induction coil suitable for use either as a rotor or a stator in electromotive devices such as an electric motor, an alternator or a generator. The induction coil is made by stamping, etching or machining slots in plural metallic sheets. The metal between the slots on each slotted sheet constitute a plurality of substantially parallel electrical conductors. In a preferred embodiment of the induction coil, the individual slotted sheets are stacked to include two or more sheets, with the conductors of the top sheet substantially filling the slots in the bottom sheet, then rolled into a first cylindrical member. The process is repeated with a second stack of slotted sheets to form a second cylindrical member having a different diameter than the first cylindrical member. The first and second cylindrical members are coaxially assembled in axial alignment to form an assembled cylindrical member. The appropriate conductors on the first and second cylindrical members are electrically interconnected then the first and second cylindrical members are impregnated and encapsulated with a suitable electrically insulating material to form a free-standing cylindrical tube. The conductors are then electrically isolated and a connector ring is affixed to the end of the tube to form an induction coil by establishing suitable electrical interconnection between the conductors on the individual slotted members. The construction permits the thickness of the conductors to be increased and the width of the slots between adjacent conductors in the assembled coil to be decreased thereby reducing conductor resistance and increasing both the conductor density and the current carrying capability of the conductors in the assembled coil.

### BACKGROUND OF THE INVENTION

1. Field of the Invention

An armature for an electromotive device and, more particularly, an induction coil having low resistance and high conductor density.

2. Prior Art

Wire wound armatures have long been known in the art pertaining to electromotive devices. More recently, armatures comprising electrical windings wherein the electrically interconnected conductor portions, which form the component coils, are printed onto the opposite sides of an insulating strip which is rolled up to form a spiral armature structure have been developed. In such an armature construction, the conductor portions (excluding the terminal ends thereof) are electrically connected to each other from one to the other side of the carrier strip by connecting means. The ends of the conductor portions are connected by way of a second printed winding section printed simultaneously with the first winding section configurated parallel to the first winding section on the same insulating carrier strip (i.e., flex circuit board). This is for the specific purpose of forming complete, closed electrical current paths on the carrier strip before the carrier strip is rolled up to form the spiral armature structure. Accordingly, because the complete closed windings are formed on the flat strip prior to the rolling up of the strip, the windings are ready to use immediately upon rolling up of the strip. The disadvantage of such printed circuit type of armature construction is that the armature have a relatively high resistance due to the small conductor thickness and a relatively large gap between conductors, the width of the gap being dependent on the thickness of the conductor traces and the limitations imposed on the gap width by the thickness of the conductive layer and the etching process itself. In addition, the presence of a backing or support material imposed by the structure reduces the packing density because the volume occupied by the support material reduces the volume available for conductive (copper) trace material.

Faulhaber, in U.S. Pat. No. 3,944,857, discloses an air-core armature for electromotive devices comprising an elongated insulating strip (i.e., flexible circuit board) rolled up to form a spiral structure composed of a plurality of radially successive layers. In this construction, an armature winding is comprised of at least one armature coil. The armature coil is comprised of a plurality of electrically interconnected (e.g., series connected or parallel-connected) component coils. Each of the component coils is formed of electrically interconnected conductor sections printed on both sides of the insulating strip. Each one of the component coils are located on different respective radially concentric layers of the spiral structure, but occupy substantially the same circumferential sector of the spiral structure, and accordingly are substantially juxtaposed in direction radially of the spiral structure. As discussed above, this construction provides an armature with relatively high resistance and interconductor gap width. Again, in addition to the relatively high resistance imposed by this construction, a substantial volume of the coil is occupied by the insulating strip thereby reducing packing density.

To overcome the aforesaid problems, including a relatively high resistance and low conductor density, inherent in armatures fabricated from flexible circuit boards, Graham et al., in U.S. Pat. No. 6,111,329, the content of which is incorporated herein be reference thereto, disclose an armature fabricated from a pair of precision machined copper plates cut in a pattern to produce a series of axially extending conductors with each conductor being separated from (parallel) adjacent conductors by a slot. The precision machined plates are rolled to form two telescoping, hollow cylinders with each cylinder having a pattern of parallel conductors representing a half-electric circuit. The outer surface of the inner cylinder is wrapped with several layers of glass fibers for subsequent structural stability and mechanical separation. The glass fiber-wrapped inner cylinder is axially aligned inside the outer cylinder. The outer surface of the telescoped structure is also wrapped with several layers of glass fibers for subsequent structural stability. The conductive bands from the outer cylinder being the near mirror image of the conductive bands of the inner cylinder are helically coupled to form a complete electrical circuit. The resulting tubular structure is impregnated with an encapsulating resin for further structural stability and insulation. The result is a freestanding ironless core inductive armature coil. While the use of layered slotted metallic plated provides an armature having thicker conductors and a smaller gap therebetween (the metallic plate is etched from both sides), the etching process imposes limitations on the gap width that is related to the thickness of the sheet metal plate. Similarly, the construction of a die suitable for stamping the metal plates in order to provide narrow slots between parallel conductors imposes practical limitations on the cost production of such an armature comprising the stamped plate due to the cost of sharpening and/or replacing the fragile die required to produce a narrow (1-10 mil) gap in a plate having a thickness greater than 10 mil.

Due to the performance and/or cost limitations inherent in prior art induction coils, particularly induction coils comprising armatures, there remains a need for an induction coil having high conductor density, low electrical resistance and a method for making the induction coil.

### SUMMARY

The present invention discloses an induction coil suitable for use as an armature in an electromotive device. The induction coil comprises a plurality of tubular members wherein an outer tubular member coaxially overlies an inner tubular member. Each tubular member comprises a plurality of elongate, parallel, electrically conductive strips having a gap between adjacent electrically conductive strips. Each of the parallel conductive strips comprising a tubular member most preferably has a rectangular cross section, a strip width and a strip thickness. The gap between adjacent conductive strips in a tubular member is less than 50% of the strip thickness and preferably about 10% of the strip thickness. Each of the tubular members is made by the superpimposing first and second metallic plates, each plate having a plurality of slots separating adjacent conductive strips. The slots between adjacent conductive strips have a slot width that is greater than the strip width and the gap width. The first and second plates are superimposed in such a way that the conductive strips on the first plate overlie corresponding slots in the second plate. Pressure is then applied to the first and second plates to force the conductive strips in the respective plates into the corresponding slots in the other plate so that the conductive strips on both plates are coplanar and form a composite sheet wherein a portion of the composite sheet is laminate and another portion of the composite sheet bearing the conductive strips is coplanar. The composite sheet is then rolled into a cylinder. The induction coil is then assembled from two or more tubular members in accordance with the method disclosed in U.S. Pat. No. 6,111,329, discussed above. The gap between conductive strips in the induction coil is less than 50% of the strip thickness.

The features of the invention believed to be novel are set forth with particularity in the appended claims. However the invention itself, both as to organization and method of operation, together with further objects and advantages thereof may be best be understood by reference to the following description taken in conjunction with the accompanying drawings in which:

### BRIEF DESCRIPTION OF THE DRAWINGS

FIG. 1 is a top view of a first slotted metallic sheet used to form a tubular member, which, in turn, is used to fabricate an induction coil in accordance with a preferred embodiment of the present invention.

FIG. 2 is a top perspective view of a first slotted metallic sheet being positioned to overlie a second slotted metallic sheet.

FIG. 3 is a top view of the two slotted metallic sheets in accordance with FIGS. 1 and 2 after superposition and compression of the sheets to form a laminate structure.

FIG. 4 is a perspective view of the laminate structure illustrated in FIG. 3, rolled from bottom to top to form a cylinder.

FIG. 5 is a cross-sectional view of the cylindrical member of FIG. 4, taken along section line 5-5.

FIG. 6 is an enlarged portion of the cross-sectional view of the cylindrical member of FIG. 5 showing the structure of the edge of the cylindrical member.

FIG. 7 is a top view of a slotted sheet of conductive material, the slots being adapted to registerably receive a conductive strip, such as the member indicated at numeral 80 (FIG. 8) therewithin.

FIG. 8 is a top view of a strip of conductive material dimensioned to fit within a slot of the sheet 70 of FIG. 7 to provide a small gap between adjacent conductive strips.

FIG. 9 is a top view showing two sheets of pre-cut or pre-formed conductive material for making a slotted sheet of conductive material in accordance with a third embodiment of the present invention.

FIG. 10 illustrates a slotted sheet wherein the two sheets of pre-formed conductive material of FIG. 9 wherein the conductive strips on respective sheets are interleaved (i.e., matingly fitted together so that the conductive strips on the sheets are juxtaposed) to form a slotted sheet in accordance with a third embodiment of the present invention wherein the width of the gaps between adjacent conductive strips in the interleaved sheet are uniform in size and less than the thickness of the conductive strips.

### DESCRIPTION OF THE PREFERRED EMBODIMENTS

The introduction of induction coils comprising a plurality of slotted metal sheets or plates in accordance with the prior art provides a free-standing coil having lower resistance than wire wound or printed circuit-type coils. To further improve the electrical characteristics of metal plate coils, it is desirable to minimize the gap width between conductive strips and increase the thickness of the conductive strips. Prior art machining methods have inherent practical limitations, which impose a strip thickness/gap size ratio that is substantially constant. In a first preferred embodiment of the present invention, a tubular member adapted to be mated with a similar member to form an induction coil having relatively thick conductive strips, when compared to conventional coils, and a gap width that is substantially independent of strip thickness is disclosed.

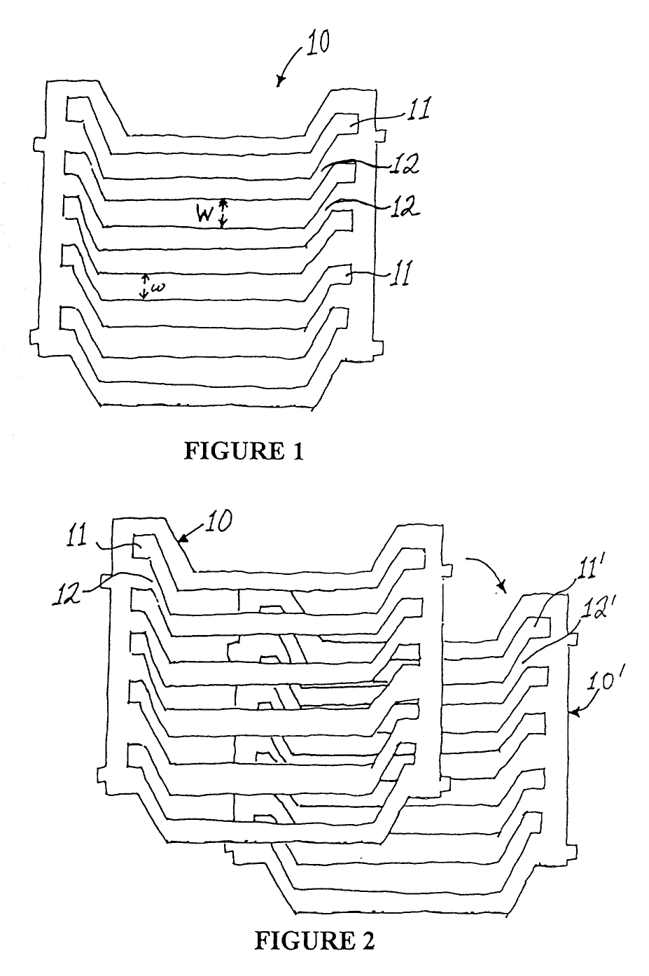

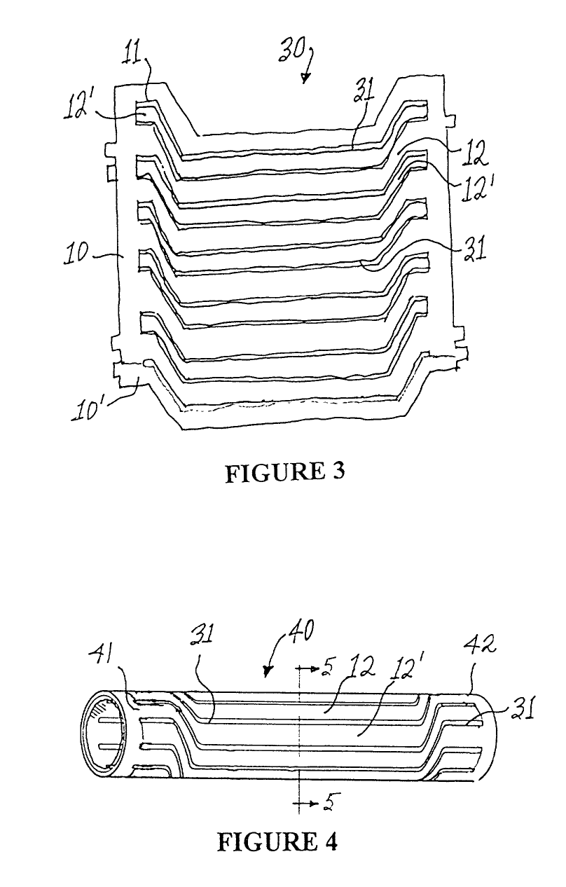

With reference to FIG. 1, a slotted metallic plate 10 having a plurality of slots 11 interposed between parallel conductive strips 12 is shown in top view. The plurality of slots 11 have a slot width W that is slightly greater than the conductive strip width w. Owing to the relatively large slot width W, the slots 11 can be inexpensively cut in the metallic plate 10 by any precision machining method such as chemical etching or stamping. When two slotted metal plates 10 are superimposed such that the conductive strips 12 on the metallic plate 10 overlie the slots 11′ in a second metallic plate 10′, as shown in FIG. 2 and formed, such as, for example, by compression, to force the conductive strips 12 on the first slotted metallic plate 10 into the corresponding slots 11′ on the second slotted plate 10′, a composite sheet 30 is formed as illustrated in top view in FIG. 3.

FIG. 3 is a top view of the two slotted metallic sheets 10 and 10′ in accordance with FIGS. 1 and 2 after superposition and compression of the sheets to form a composite sheet 30. In the composite sheet 30, the conductive strips 12 on slotted plate 10 substantially fill the slots 11′ of slotted sheet 10′, leaving a small gap 31 between adjacent conductive strips 12 and 12′ in the composite sheet 30. The thickness of the conductive strips 12 and 12′ will depend, of course, on the thickness of the metal plates used to make the slotted metallic plates 10 and 10′. For example, if the thickness of the sheets used to make slotted metallic plates 10 and 10′ is 20 mil, the gap width 31 may be as small as 1-2 mil in the composite sheet, the gap width being limited only by the requirement that the gap width be sufficiently large to provide electrical isolation between conductive strips without arcing or voltage breakdown in the gap. The composite sheet 30 is then rolled to form a cylindrical member.

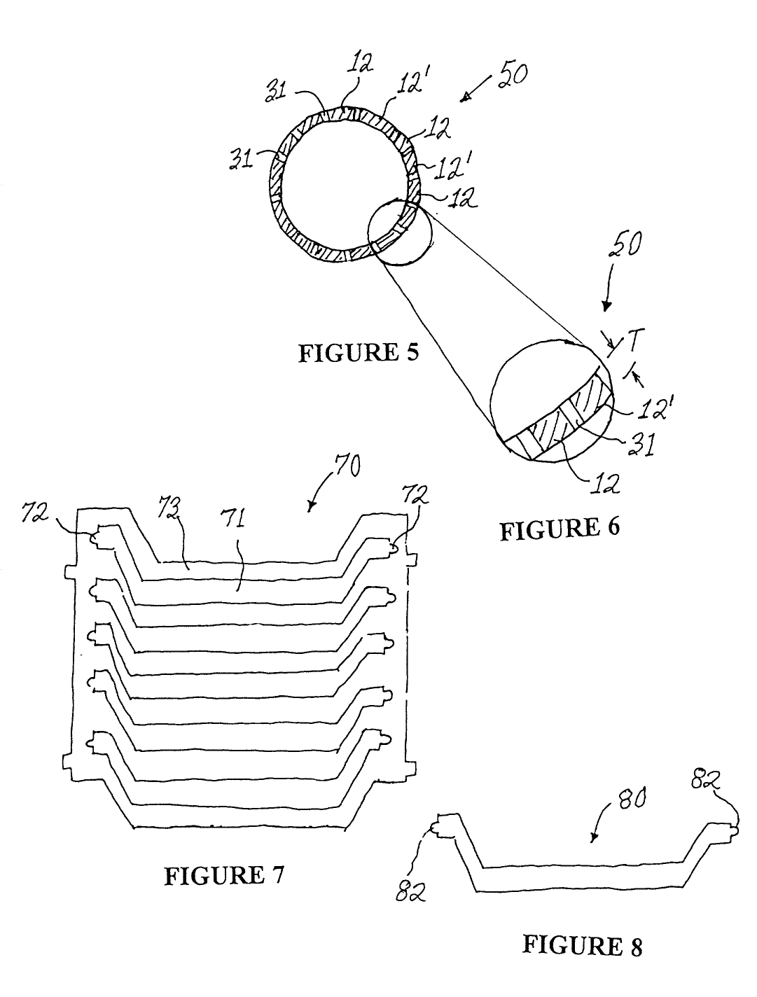

FIG. 4 is a perspective view of the composite sheet 30, illustrated in FIG. 3, rolled to form a cylindrical member 40. FIG. 5 is a cross-sectional view of the cylindrical member 40 taken along section line 5-5 of FIG. 4. An enlarged portion of the edge of the cylindrical member, viewed along section line 5-5, is shown in FIG. 6. After opposing edges of the slotted sheet 30 are brought together, they are affixed to one another to form a tubular member 50 for use in the assembly of an induction coil in accordance with a first preferred embodiment of the present invention and the assembly method disclosed in U.S. Pat. No. 6,111,329.

Turning now to FIGS. 7 and 8, an induction coil in accordance with a second preferred embodiment of the present invention is described. A slotted metallic plate 70 is made by stamping, etching or machining a plurality of identical, parallel slots 71 into a metallic sheet. The lateral ends 72 of the slots 71 are shaped to receive the lateral ends 82 of a modular conductive strip 80 in registrable relationship therewith. The width of the modular conductive strip 80 is less than the width of the slots 71 in the slotted metallic plate 70 in order to leave a small gap between adjacent conductive strips 73 and 80 when the conductive strips 80 are disposed within the slots 71. When a plurality of the strips 80 have been disposed to fill all the corresponding slots 71, the lateral ends 82 are fused or otherwised mechanically or materially connected to the metallic plate 70 and the resulting slotted metallic sheet rolled and assembled to form an induction coil as discussed above.

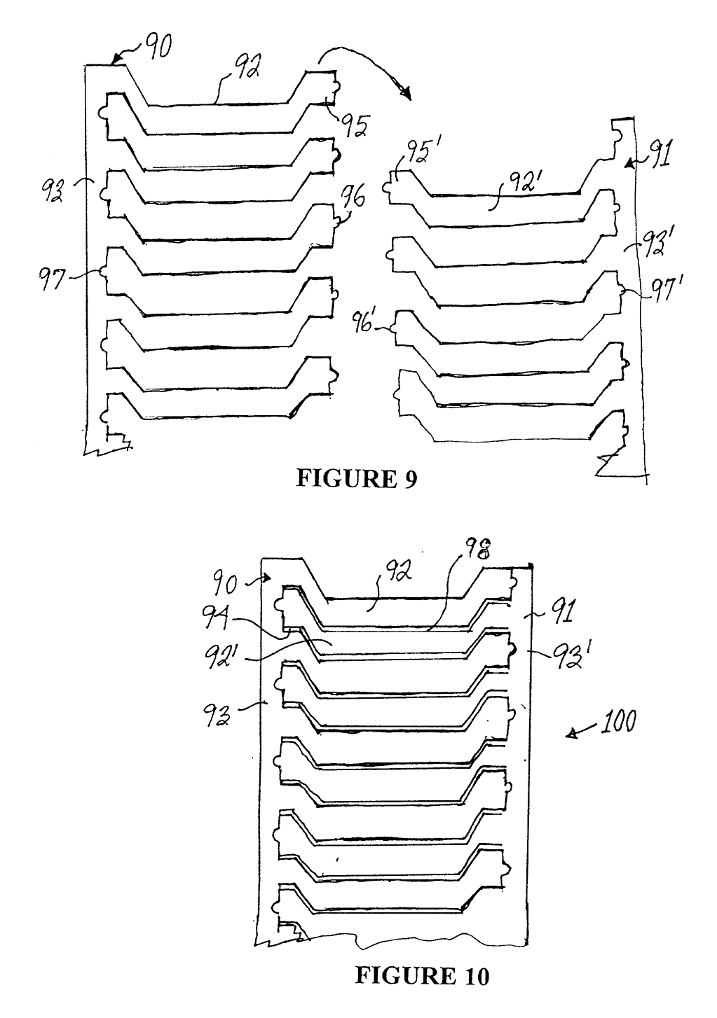

A third preferred embodiment of a slotted conductive sheet useful for making an induction coil and a method for making the slotted sheet is illustrated in FIGS. 9 and 10. Turning first to FIG. 9, two formed sheets 90 and 91 are formed or stamped to provide a plurality of conductive strips 92 and 92′ respectively. The conductive strips 92 and 92′ are attached to a support strip 93 and 93′ at a lateral edge thereof. The opposing free end 95 and 95′ of the conductive strips 92 and 92′ have registration means 96 and 96′ thereon that matingly and registerably engage mating registration means 97′ and 97 on the support strips 93 and 93′. The slotted sheets 90 and 91 are matingly juxtaposed with each other in registrable alignment, as shown in FIG. 10, and the free ends 95 and 95′ of the conductive strips are affixed to the engaging means 97′ and 97 respectively on the support strips 91 and 90 respectively to form a slotted sheet 100. The gap 98 between conductive strips 92 and 92′ in slotted sheet 100 is preferably less than the thickness of the conductive strips 92 and 92′ (the thickness of the conductive strips 92 and 92′ is not visible in FIGS. 9 and 10).

It has been shown that induction coils having a packing density greater than heretofor deemed possible in the art can be achieved by the novel slotted sheets of conductive material described hereinabove. Embodiments of the slotted sheets can be made by three different methods as described. While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What we claim is:

1. An induction coil comprising a plurality of tubular members, each of said tubular members further comprising a plurality of elongate, parallel, electrically conductive strips, each of said strips having a strip length, a strip width and a strip thickness, each of said parallel electrically conductive strips being separated from adjacent parallel strips by a gap having a gap width, wherein said gap width is less than said strip thickness.

2. An induction coil in accordance with claim 1 wherein said gap width is less than 1 millimeter.

3. An induction coil in accordance with claim 1 wherein said electrically conductive strips are rectangular in cross-section.

4. An induction coil comprising a plurality of concentric tubular members, each of said tubular members further comprising a plurality of elongate, parallel, electrically conductive strips, each of said strips having a strip length, a strip width and a strip thickness, each of said parallel electrically conductive strips being separated from adjacent parallel strips by a gap having a gap width, wherein said gap width is less than said strip width and said strip thickness, and wherein at least one electrically conductive strip on one said tubular member is in electrical communication with an electrically conductive strip on a different tubular member.

5. An induction coil in accordance with claim 4 wherein said gap width is less than 1 millimeter.

6. An induction coil in accordance with claim 4 wherein said electrically conductive strips are rectangular in cross-section.

7. An induction coil in accordance with claim 5 wherein said electrically conductive strips are rectangular in cross-section.

8. A method for making an induction coil comprising the steps of:
(a) presenting first and second sheets of an electrically conductive material having a plurality of electrically conductive strips thereon, each of said strips on said first and second sheet being separated from an adjacent strip by a slot therebetween; then
(b) placing said first sheet adjacent said second sheet such that said strips on said first sheet lie within said slots on said second sheet; then
(c) rolling said first and second sheets to form a first cylinder having an inner diameter; then
(d) forming a second cylinder in accordance with steps (a)-(c) having an ouside diameter that is less than said inner diameter of said first cylinder; then
(e) disposing said second cylinder within said first cylinder in axial alignment therewith; then
(f) forming electrical connections between said conductive strips on said first cylinder and conductive strips on said second cylinder.

9. The method of claim 8 further comprising the step of wrapping said second cylinder with at least one layer of glass fiber prior to disposition of said second cylinder within said first cylinder.

10. The method of claim 8 further comprising impregnating and encapsulating said first and second cylinders in a resin following step (f).
